(19) United States
(12) Patent Application Publication
(10) Pub. No.: US 2010/0316018 A1
(43) Pub. Date: Dec. 16, 2010

(54) Network-based handover control mechanism

(76) Inventors: Zoltan Richard Turanyi, Szentendre (HU); Tomas Goldbeck-Lowe, Saltsjo-Boo (SE); Gunnar Nilsson Cassel, Lidingo (SE)

Correspondence Address: ERICSSON INC., 6300 LEGACY DRIVE, M/S EVR 1-C-11, PLANO, TX, 75024, US

(21) Appl. No.: 12/518,635

(22) PCT Filed: Dec. 14, 2006
(86) PCT No.: PCT/EP2006/069714

§ 371 Date: Apr. 16, 2010

(51) Int. Cl. H04W 4/00

(52) U.S. Cl. 370/331

(57) ABSTRACT

A method of performing network-based handover control in respect of a mobile node 1 having multi-access capabilities, wherein IP packets are routed to and from the mobile node using a Mobile IP protocol. The method comprises informing a Home Agent 4 within a home network of two or more care-of-addresses available to a mobile node 1, at the Home Agent 4, selecting one of said care-of-addresses, and informing the mobile node of the selection, at the mobile node, performing a handover to the selected care-of-address, and at the Home Agent binding the selected care-of-address to a home address of the mobile node.

### TECHNICAL FIELD

The present invention relates to a network-based handover control mechanism in a Mobile IP architecture.

### BACKGROUND

In order to provide a stable IP connection for user terminals moving within and between (access) networks, the Internet Engineering Task Force (IETF) has specified a protocol known as Mobile IP. Mobile IP for IPv6 is specified in RFC 3775—“Mobility Support in IPv6”. According to Mobile IPv6, the current location of a user terminal or Mobile Node (MN) within the global network is stored in a node called a Home Agent (HA). The HA dynamically updates the current location of the MN as it moves, in order to make the MN reachable for other nodes trying to connect to it. These other nodes are referred as Correspondent Nodes (CN).

A MN is allocated a stable IP address, which is referred as a Home Address (HoA). When the MN is away from its home network (i.e. the network which assigned the HoA), the HA receives traffic on the behalf of the MN and then tunnels it towards the MN, i.e. communications between the MN and the CN are sent via the HA. The current location of the MN is indicated by a care-of address (CoA), and thus when the HA needs to forward a packet to the MN's current location, the HA must map the HoA to CoA. The mapping between HoA and CoA is called a “binding”. The MN informs the HA of this binding using a Binding Update (BU) message. The HA confirms that the binding has been registered by returning a Binding Acknowledge (BA) message to the MN.

Mobile IPv6 defines a mechanism referred to as “route optimization” which can be used to optimise the route taken by traffic between the MN and the CN, removing the HA from the route. However, route optimization is not a mandatory part of the protocol and it may not always be available for various reasons. For example, some Network Address Translation (NAT) servers may cause problems for route optimization effectively rendering its use impossible.

Mobile IP has also been specified for IPv4 in IETF RFC 3220 “Mobility Support in IPv6”. The main differences between Mobile IPv6 and Mobile IPv4 are that the former supports route optimisation whilst the latter does not, and that Mobile IPv4 requires the presence in the visited network of a Foreign Agent. Packets are routed from the Home Agent to the MN via the Foreign Agent (either using an IP address allocated to the MN within the same subnet as the Foreign Agent, or using an IP address that terminates at the Foreign Agent, a so-called “colocated care-of-address”). In Mobile IPv4, the Binding Update and Binding Acknowledge messages are referred to as Registration Request and Registration Reply respectively. For the purpose of this discussion, we can refer generically to “Location Update” and “Location Update Acknowledge” messages.

Recent developments in mobile communication have introduced a need to support multi-access capabilities for MNs. Consider for example a MN which is simultaneously reachable at two different CoAs. One of the CoAs may be associated, for example, with a 3G access network whilst the other may be associated with a WLAN access network. The “monami6” IETF working group is currently working on the provision of multi-access support in Mobile IPv6. However, with the conventional approach to Mobile IP, it is the MN that selects its attachment point to the network. Whilst the HA may be aware of the multiple CoA available to a MN, this knowledge only allows the HA to route packets to the MN using one of these addresses. The HA cannot instruct the MN to send outgoing packets via an attachment point associated with a particular CoA, i.e. it cannot instruct the MN to perform a “handover”.

This conflicts with the conventional cellular network approach where it is the network that decides a terminal's attachment point. A network operator may wish to retain access control for a number of reasons, e.g. to allocate attachment points based upon user subscriptions or to ensure appropriate quality of service. Although with Mobile IP the Home Agent has the option to reject Location Update messages for policy reasons, this only allows the network to reject certain handovers attempted by the MN, it does not allow the network to actively initiate handovers.

### SUMMARY

It is an object of the present invention to provide a mechanism within Mobile IP which allows the network to determine the attachment point(s) used by a Mobile Node to access network services. This object is achieved by allowing a Mobile Node to report multiple care-of addresses to its Home Agent, with the Home Agent selecting the address to be used.

According to a first aspect of the present invention there is provided a method of performing network-based handover control in respect of a mobile node having multi-access capabilities, wherein IP packets are routed to and from the mobile node using a Mobile IP protocol, the method comprising:
informing a Home Agent within a home network of two or more care-of-addresses available to a mobile node;
at the Home Agent, selecting one of said care-of-addresses, and informing the mobile node of the selection;
at the mobile node, performing a handover to the selected care-of-address; and
at the Home Agent binding the selected care-of-address to a home address of the mobile node.

Embodiments of the present invention enable the Home Agent to initiate a handover procedure for the mobile node on an informed basis, whilst still performing the actual handover at the mobile node. Embodiments of the invention are provided which have a minimal impact on existing Mobile IP protocols.

In a preferred embodiment of the invention, said step of performing a handover at the mobile node comprises, upon receipt of said selection, sending a location update message to the Home Agent, the location update message containing the selected care-of-address, and upon receipt of said location update message at the Home Agent carrying out said step of binding the selected care-of-address to a home address of the mobile node. This approach may therefore utilise the conventional binding update exchange between the mobile node and the Home Agent to update the binding table at the Home Agent, following selection of the care-of-address by the Home Agent and notification to the mobile node. This reuse of the binding update exchange means that the modifications required to existing protocols are minimised.

Embodiments of the invention use a location offer message sent from the mobile node to the Home Agent to inform the Home Agent of the available care-of-addresses, and a location selection message sent from the Home Agent to the mobile node to identify the selection to the mobile node. In the case of MIPv6, the location offer message may have the structure of a Binding Update message, with the addition of a header field indicating that the message is an offer and an extension containing said at least two care-of-addresses. The location selection message may have the structure of a Binding Acknowledge message with the addition of a header field indicating that the message is a selection and an extension containing the selected care-of-address. This reuse of existing message structures minimises the impact on existing protocols.

In the case of MIPv4 protocol, said location offer message may have the structure of a Registration Request message, with the addition of a header field indicating that the message is an offer and an extension containing said at least two care-of-addresses. The location selection message has the structure of a Registration Reply message with the addition of a header field indicating that the message is a selection and an extension containing the selected care-of-address. Again, this reuse of existing message structures minimises the impact on existing protocols.

According to a second aspect of the present invention there is provided a user terminal comprising:
means for implementing a Mobile IP protocol;
means for receiving a selection response message from the Home Agent, the response message containing a care-of-addresses selected by the Home Agent; and
means for performing a handover to the selected care-of-address.

According to a third aspect of the present invention there is provided a user terminal comprising network-based server for acting as a Home Agent according to a Mobile IP protocol, the server comprising:
means for selecting a care-of-address from two or more care-of-addresses allocated to a mobile node;
means for informing said mobile node of the selection; and
   means for binding the selected care-of-address to a home address of the mobile node.

### BRIEF DESCRIPTION OF THE DRAWINGS

FIG. 1 illustrates schematically a communications system employing Mobile IPv6;

FIG. 2 shows the structure of a Mobile IPv6 Binding Update message;

FIG. 3 shows the structure of a Location Offer message according to Mobile IPv6; and

FIG. 4 illustrates signalling used to implement a network based access control mechanism.

### DETAILED DESCRIPTION

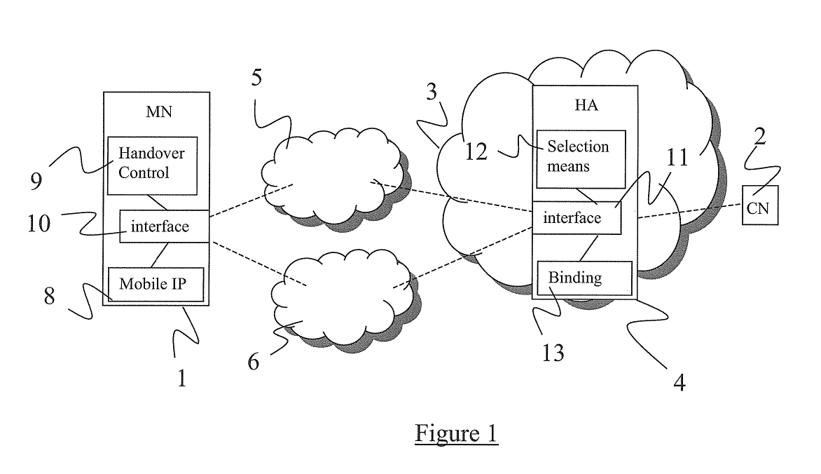

FIG. 1 illustrates schematically a communications system for enabling communication between a pair of user terminals, a first of which is identified as a Mobile Node (MN) 1 and a second of which is referred to as a Correspondent Node (CN) 2. The MN 1 subscribes to a home network 3 which facilitates roaming by its subscribers using a Home Agent (HA) 4. As has already been described, the HA allocates a stable IP address to the MN, and the MN uses Location Updates to keep the HA informed of its current care-of-address (CoA). In the scenario shown in FIG. 1, the MN 1 has roamed into a location where two different access networks 5,6 are simultaneously available. The exact nature of these networks is not of importance to this discussion. The MN 1 and the HA 4 comprise various functional means as will be described further below.

It is assumed here that the MN 1 is directly responsible for detecting available access networks, for attaching to these, and for routing traffic via a chosen access network (entity 8 in FIG. 1). However, as will now be discussed, it is the HA 4 which is responsible for instructing the MN which access network to use.

Considering the scenario of FIG. 1, it is assumed that the MN has negotiated a secure signalling link with the HA. Using this secure link, the MN reports (entities 9 and 10 in FIG. 1) the CoAs available to it, to the HA. The HA receives this information (at entity 11) and then applies some policy (not specified here) to select one of these CoAs (at entity 12), and sends a message to instruct the MN to use the selected CoA. More specifically, a new protocol is defined comprising a pair of messages which are similar to the conventional Location Update and Location Acknowledge messages (i.e. Binding Update/Acknowledge or Registration Request/Reply). These new messages are referred to as “Location Offer” and “Location Select” respectively.

The new Location Offer message is capable of reporting multiple care-of addresses, without actually changing the binding at the HA. The meaning of this message is not to request a Binding or a Registration, merely to inform the Home Agent of available CoA (perhaps accompanied by other information about the access network providing the care-of address).

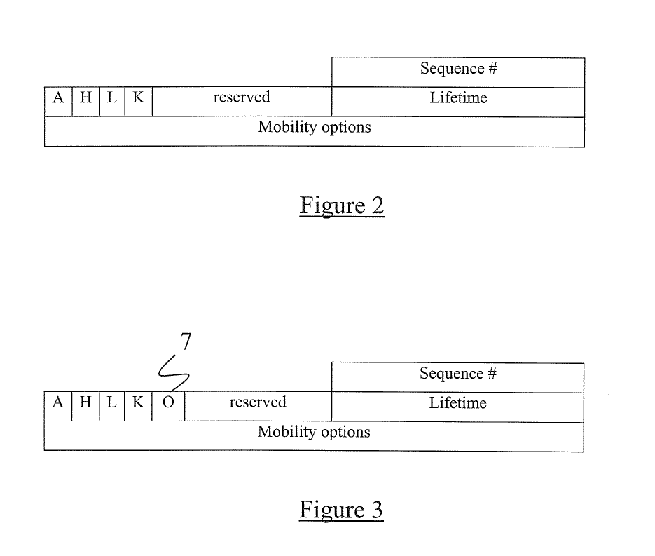

RFC 3775 defines the Binding Update message as shown in FIG. 2. One way to implement the Location Offer message for Mobile IPv6 is illustrated in FIG. 3. This Location Offer message uses the same message code and layout as the Binding Update message. However, the Mobility options part contains multiple available Care-of Address options in their order of preference. The newly added “0” bit (identified by reference numeral 7 in FIG. 3) is set to indicate a Location Offer message. The lifetime field is not used, whilst the sequence number (“Sequence #”) is from the same sequence number space as that of the Binding Update messages.

The new Location Select message is capable of reporting (to the MN) a CoA selected by the HA. For IPv6, Location Select messages use the same code and format as Binding Acknowledge messages, but they have a “selected” Care-of Address option as well as a newly defined header bit to indicate that the message is a Location Select message. With this approach, the Location Select message may be sent to the selected CoA or to any other available CoA for the MN. However, if it is required that the HA send the Location Select message only to the selected CoA, the Selected Care-of Address option may be omitted from the Location Select message as this is now redundant information.

Considering further application of this mechanism to Mobile IPv6, upon receipt of a Location Select message, the MN must implement the selection instructed by the HA. It does this using the regular Mobile IP Binding Update/Acknowledge exchange, i.e. the Binding Update contains the selected CoA. The MN may also send Route Optimization (IPv6) messages to Correspondent Nodes, (including return routability or other security procedure) to cause subsequent packets sent from the Correspondent Nodes to be routed directly to the selected CoA.

Upon receipt of a Location Offer message, the HA (entity 13) selects an appropriate CoA as already discussed. Whilst at this stage the HA does not implement the binding, it may record the mapping for subsequent use. This would allow the HA, for example, to verify that any subsequently received Binding Update matches a previously selected CoA (and that the MN is not trying to override the selection of the HA).

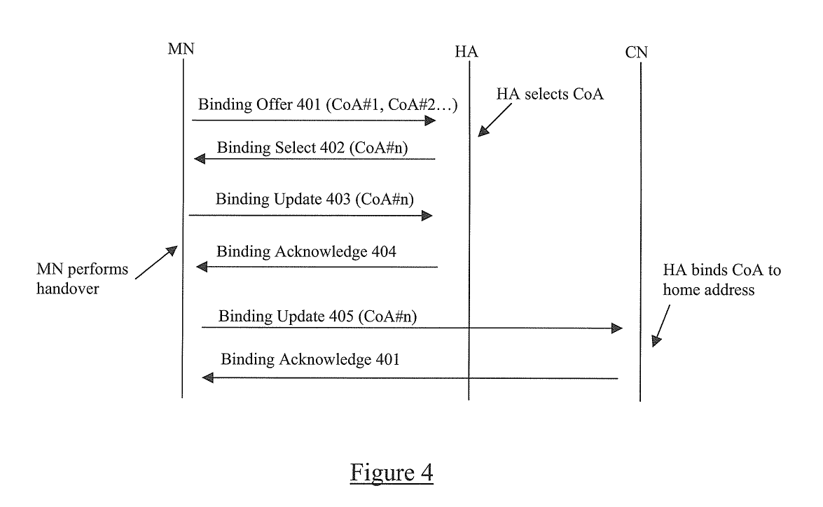

FIG. 4 illustrates signalling associated with this process.

It is possible for the HA to asynchronously change the access being used by the MN. In this case, the process is not initiated by the sending of a Location Offer message 401 from the MN to the HA. Rather, the HA sends a Location Select message 402 to the MN containing a selected CoA. The MN shall then execute a Binding Update 403 to the specified address. If the MN has not replied to the HA (with a Binding Update) after a number of retransmissions, the HA can assume that the MN is not available at the specified CoA, and will remove the CoA from its list of available CoAs. It may select another CoA and resend the Binding Select message

It is noted that a Location Offer message may contain additional options that describe parameters associated with the reported CoAs, such as access technology, owner of the access, available resources in the access (if known to the MN), user preferences, etc. The HA can the take the access properties into account when making a CoA selection.

Considering now Mobile IP for IPv4, as the Binding Update message is not available, a new bit can be defined in the Registration Request message to indicate a Location Offer message. In addition, extensions are defined to list a number of available CoA. Any of the available Foreign Agents (FAs) can be used to send such messages. It is possible this way to offer both FA and co-located care-of addresses to the HA for selection. Correspondingly, the Registration Reply message is extended with a flag to indicate a Location Select message and an extension defined to inform the MN of the selected CoA.

It is possible to remove the need for the Binding Update related exchange by requiring the MN to implement the selected CoA upon receipt of the Location Select message. In a first step, the MN reports the available CoAs as described above. The HA then makes a selection and sends this back to the MN. However, in contrast to the approach described above, this response is taken by the MN as an instruction to use the new CoA. The HA records the new binding in its binding mappings database. The MN merely acknowledges receipt of the selection to the HA. Whilst this approach requires a greater change to the existing protocols than the approach requiring the sending of the Binding Update/Registration Request, it does have the advantage that it reduces the scope for “misbehaviour” on the part of the MN, e.g. a delay in sending the Binding Update 403 to the HA.

It will be appreciated by the person of skill in the art that various modifications may be made to the above described embodiments without departing from the scope of the present invention.

1. A method of performing network-based handover control in respect of a mobile node having multi-access capabilities, wherein IP packets are routed to and from the mobile node using a Mobile IP protocol, the method comprising:
sending a notification from said mobile node to a Home Agent within a home network, the notification containing two or more IP care-of-addresses available to the mobile node;
at the Home Agent, selecting one of said care-of-addresses, and informing the mobile node of the selection;
at the mobile node, performing a handover to the selected care-of-address; and at the Home Agent, binding the selected care-of-address to a home address of the mobile node.

2. The method according to claim 1, wherein said step of informing comprises sending a location offer message from the mobile node to the Home Agent, the message containing said two or more IP care-of-addresses.

3. The method according to claim 1, wherein said step of binding the selected IP care-of-address to a home address of the mobile node at the Home Agent is carried out in response to the selection of an IP care-of-address at the Home Agent.

4. The method according to claim 1, wherein said step of performing a handover at the mobile node comprises, upon receipt of said selection, sending a location update message to the Home Agent, the location update message containing the selected IP care-of-address, and upon receipt of said location update message at the Home Agent carrying out said step of binding the selected IP care-of-address to a home address of the mobile node.

5. The method according to claim 4, wherein said Mobile IP protocol is Mobile IPv6 protocol, and said location update message is a Binding Update.

6. The method according to claim 4, wherein said Mobile IP protocol is the Mobile IPv4 protocol, and said location update message is a Registration Request.

7. The method according to claim 2, wherein said Mobile IP protocol is the Mobile IPv6 protocol, and said location offer message has the structure of a Binding Update message, with the addition of a header field indicating that the message is an offer and an extension containing said at least two IP care-of-addresses.

8. The method according to claim 7, wherein the Home Agent informs the mobile node of the care-of address selection by sending a location selection message to the mobile node, the location selection message having the structure of a Binding Acknowledge message with the addition of a header field indicating that the message is a selection and an extension containing the selected IP care-of-address.

9. The method according to claim 2, wherein said Mobile IP protocol is the Mobile IPv4 protocol, and said location offer message has the structure of a Registration Request message, with the addition of a header field indicating that the message is an offer and an extension containing said at least two IP care-of-addresses.

10. The method according to claim 9, wherein the Home Agent informs the mobile node of the IP care-of address selection by sending a location selection message to the mobile node, the location selection message having the structure of a Registration Reply message with the addition of a header field indicating that the message is a selection and an extension containing the selected IP care-of-address.

11. The method according to claim 1, wherein the Home Agent informs the mobile node of the IP care-of address selection by sending a location selection message to the mobile node at the selected care-of address.

12. A user terminal comprising:
means for implementing a Mobile IP protocol;
means for sending a notification to a Home Agent within a home network, the notification containing two or more IP care-of-addresses available to the mobile node;
means for receiving a selection response message from the Home Agent, the response message containing care-of-addresses selected by the Home Agent from the IP care-of-addresses provided to it by the mobile node; and
means for performing a handover to the selected care-of-address.

13. A network-based server for acting as a Home Agent according to a Mobile IP protocol, the server comprising:
means for receiving a notification from a mobile node, the notification containing two or more IP care-of-addresses available to the mobile node;
means for selecting a care-of-address from said two or more IP care-of-addresses;
means for informing said mobile node of the selection; and
means for binding the selected care-of-address to a home address of the mobile node.
